(19) United States
(12) Patent Application Publication
(10) Pub. No.: US 2018/0199057 A1
(43) Pub. Date: Jul. 12, 2018

(54) Method and Apparatus of Candidate Skipping for Predictor Refinement in Video Coding

(71) Applicant: MEDIATEK INC., Hsin-Chu (TW)

(72) Inventors: Tzu-Der CHUANG, Hsinchu (TW); Chih-Wei HSU, Hsinchu (TW); Ching-Yeh CHEN, Hsinchu (TW)

(21) Appl. No.: 15/868,995

(22) Filed: Jan. 11, 2018

Related U.S. Application Data
(60) Provisional application No. 62/445,287, filed on Jan. 12, 2017.

(51) Int. Cl. H04N 19/533; H04N 19/577; H04N 19/573

(52) U.S. Cl. CPC H04N 19/533; H04N 19/573; H04N 19/577

(57) ABSTRACT

Method and apparatus of using motion refinement with reduced bandwidth are disclosed. According to one method, a predictor refinement process is applied to generate motion refinement for the current block by searching among multiple motion vector candidates using reference data comprising the target motion-compensated reference block, where if a target motion vector candidate requires target reference data from the target motion-compensated reference block being outside the valid reference block, the target motion vector candidate is excluded from said searching the multiple motion vector candidates or a replacement motion vector candidate closer to a center of the corresponding block of the current block is used as a replacement for the target motion vector candidate. In another method, if a target motion vector candidate belongs to one or more target fractional-pixel locations, a reduced tap-length interpolation filter is applied to the target motion vector candidate.

### CROSS REFERENCE TO RELATED APPLICATIONS

The present invention claims priority to U.S. Provisional Patent Application, Ser. No. 62/445,287, filed on Jan. 12, 2017. The U.S. Provisional Patent Application is hereby incorporated by reference in its entirety.

### FIELD OF THE INVENTION

The present invention relates to motion compensation using predictor refinement process, such as Pattern-based MV Derivation (PMVD), Bi-directional Optical flow (BIO) or Decoder-side MV Refinement (DMVR), to refine motion for a predicted block. In particular, the present invention relates to bandwidth reduction associated with the DMVR process.

### BACKGROUND AND RELATED ART

Pattern-Based MV Derivation (PMVD) In VCEG-AZO7 (Jianle Chen, et al., Further improvements to HMKTA-1.0, ITU-Telecommunications Standardization Sector, Study Group 16 Question 6, Video Coding Experts Group (VCEG), 52^{nd} Meeting: 19-26 Jun. 2015, Warsaw, Poland), a pattern-based MV derivation (PMVD) method is disclosed. According to VCEG-AZ07, the decoder-side motion vector derivation method uses two Frame Rate Up-Conversion (FRUC) Modes. One of the FRUC modes is referred as bilateral matching for B-slice and the other of the FRUC modes is referred as template matching for P-slice or B-slice. FIG. 1 illustrates an example of FRUC bilateral matching mode, where the motion information for a current block 110 is derived based on two reference pictures. The motion information of the current block is derived by finding the best match between two blocks (120 and 130) along the motion trajectory 140 of the current block 110 in two different reference pictures (i.e., Ref0 and Ref1). Under the assumption of continuous motion trajectory, the motion vectors MV0 associated with Ref0 and MV1 associated with Ref1 pointing to the two reference blocks 120 and 130 shall be proportional to the temporal distances, i.e., TD0 and TD1, between the current picture (i.e., Cur pic) and the two reference pictures Ref0 and Ref1.

FIG. 2 illustrates an example of FRUC template matching mode. The neighboring areas (220a and 220b) of the current block 210 in a current picture (i.e., Cur pic) are used as a template to match with a corresponding template (230a and 230b) in a reference picture (i.e., Ref0 in FIG. 2). The best match between template 220a/220b and template 230a/230b will determine a decoder derived motion vector 240. While Ref0 is shown in FIG. 2, Ref1 can also be used as a reference picture.

According to VCEG-AZ07, a FRUC_mrg_flag is signaled when the merge_flag or skip_flag is true. If the FRUC_mrg_flag is 1, then FRUC_merge_mode is signaled to indicate whether the bilateral matching merge mode or template matching merge mode is selected. If the FRUC_mrg_flag is 0, it implies that regular merge mode is used and a merge index is signaled in this case. In video coding, in order to improve coding efficiency, the motion vector for a block may be predicted using motion vector prediction (MVP), where a candidate list is generated. A merge candidate list may be used for coding a block in a merge mode. When the merge mode is used to code a block, the motion information (e.g. motion vector) of the block can be represented by one of the candidates MV in the merge MV list. Therefore, instead of transmitting the motion information of the block directly, a merge index is transmitted to a decoder side. The decoder maintains a same merge list and uses the merge index to retrieve the merge candidate as signaled by the merge index. Typically, the merge candidate list consists of a small number of candidates and transmitting the merge index is much more efficient than transmitting the motion information. When a block is coded in a merge mode, the motion information is “merged” with that of a neighboring block by signaling a merge index instead of explicitly transmitted. However, the prediction residuals are still transmitted. In the case that the prediction residuals are zero or very small, the prediction residuals are “skipped” (i.e., the skip mode) and the block is coded by the skip mode with a merge index to identify the merge MV in the merge list.

While the term FRUC refers to motion vector derivation for Frame Rate Up-Conversion, the underlying techniques are intended for a decoder to derive one or more merge MV candidates without the need for explicitly transmitting motion information. Accordingly, the FRUC is also called decoder derived motion information in this disclosure. Since the template matching method is a pattern-based MV derivation technique, the template matching method of the FRUC is also referred as Pattern-based MV Derivation (PMVD) in this disclosure.

In the decoder side MV derivation method, a new temporal MVP called temporal derived MVP is derived by scanning all MVs in all reference pictures. To derive the LIST_0 temporal derived MVP, for each LIST_0 MV in the LIST_0 reference pictures, the MV is scaled to point to the current picture. The 4×4 block that pointed by this scaled MV in current picture is the target current block. The MV is further scaled to point to the reference picture that refIdx is equal 0 in LIST_0 for the target current block. The further scaled MV is stored in the LIST_0 MV field for the target current block. FIG. 3A and FIG. 3B illustrate examples for deriving the temporal derived MVPs for LIST_0 and LIST_1 respectively. In FIG. 3A and FIG. 3B, each small square block corresponds to a 4×4 block. The temporal derived MVPs process scans all the MVs in all 4×4 blocks in all reference pictures to generate the temporal derived LIST_0 and LIST_1 MVPs of current picture. For example, in FIG. 3A, blocks 310, blocks 312 and blocks 314 correspond to 4×4 blocks of the current picture (Cur. pic), LIST_0 reference picture with index equal to 0 (i.e., refidx=0) and LIST_0 reference picture with index equal to 1 (i.e., refidx=1) respectively. Motion vectors 320 and 330 for two blocks in LIST_0 reference picture with index equal to 1 are known. Then, temporal derived MVP 322 and 332 can be derived by scaling motion vectors 320 and 330 respectively. The scaled MVP is then assigned it to a corresponding block. Similarly, in FIG. 3B, blocks 340, blocks 342 and blocks 344 correspond to 4×4 blocks of the current picture (Cur. pic), LIST_1 reference picture with index equal to 0 (i.e., refidx=0) and LIST_1 reference picture with index equal to 1 (i.e., refidx=1) respectively. Motion vectors 350 and 360 for two blocks in LIST_1 reference picture with index equal to 1 are known. Then, temporal derived MVP 352 and 362 can be derived by scaling motion vectors 350 and 360 respectively.

For the bilateral matching merge mode and template matching merge mode, two-stage matching is applied. The first stage is PU-level matching, and the second stage is the sub-PU-level matching. In the PU-level matching, multiple initial MVs in LIST_0 and LIST_1 are selected respectively. These MVs includes the MVs from merge candidates (i.e., the conventional merge candidates such as these specified in the HEVC standard) and MVs from temporal derived MVPs. Two different staring MV sets are generated for two lists. For each MV in one list, a MV pair is generated by composing of this MV and the mirrored MV that is derived by scaling the MV to the other list. For each MV pair, two reference blocks are compensated by using this MV pair. The sum of absolutely differences (SAD) of these two blocks is calculated. The MV pair with the smallest SAD is selected as the best MV pair.

After a best MV is derived for a PU, the diamond search is performed to refine the MV pair. The refinement precision is 1/8-pel. The refinement search range is restricted within ±1 pixel. The final MV pair is the PU-level derived MV pair. The diamond search is a fast block matching motion estimation algorithm that is well known in the field of video coding. Therefore, the details of diamond search algorithm are not repeated here.

For the second-stage sub-PU-level searching, the current PU is divided into sub-PUs. The depth (e.g. 3) of sub-PU is signaled in sequence parameter set (SPS). Minimum sub-PU size is 4×4 block. For each sub-PU, multiple starting MVs in LIST_0 and LIST_1 are selected, which include the MV of PU-level derived MV, zero MV, HEVC collocated TMVP of current sub-PU and bottom-right block, temporal derived MVP of current sub-PU, and MVs of left and above PU/sub-PU. By using the similar mechanism as the PU-level searching, the best MV pair for the sub-PU is determined. The diamond search is performed to refine the MV pair. The motion compensation for this sub-PU is performed to generate the predictor for this sub-PU.

For the template matching merge mode, the reconstructed pixels of above 4 rows and left 4 columns are used to form a template. The template matching is performed to find the best matched template with its corresponding MV. Two-stage matching is also applied for template matching. In the PU-level matching, multiple starting MVs in LIST_0 and LIST_1 are selected respectively. These MVs include the MVs from merge candidates (i.e., the conventional merge candidates such as these specified in the HEVC standard) and MVs from temporal derived MVPs. Two different staring MV sets are generated for two lists. For each MV in one list, the SAD cost of the template with the MV is calculated. The MV with the smallest cost is the best MV. The diamond search is then performed to refine the MV. The refinement precision is 1/8-pel. The refinement search range is restricted within ±1 pixel. The final MV is the PU-level derived MV. The MVs in LIST_0 and LIST_1 are generated independently.

For the second-stage sub-PU-level searching, the current PU is divided into sub-PUs. The depth (e.g. 3) of sub-PU is signaled in SPS. Minimum sub-PU size is 4×4 block. For each sub-PU at left or top PU boundaries, multiple starting MVs in LIST_0 and LIST_1 are selected, which include the MV of PU-level derived MV, zero MV, HEVC collocated TMVP of current sub-PU and bottom-right block, temporal derived MVP of current sub-PU, and MVs of left and above PU/sub-PU. By using the similar mechanism as the PU-level searching, the best MV pair for the sub-PU is determined. The diamond search is performed to refine the MV pair. The motion compensation for this sub-PU is performed to generate the predictor for this sub-PU. For the PUs that are not at left or top PU boundaries, the second-stage sub-PU-level searching is not applied, and the corresponding MVs are set equal to the MVs in the first stage.

In this decoder MV derivation method, the template matching is also used to generate a MVP for Inter mode coding. When a reference picture is selected, the template matching is performed to find a best template on the selected reference picture. Its corresponding MV is the derived MVP. This MVP is inserted into the first position in AMVP. AMVP represents advanced MV prediction, where a current MV is coded predictively using a candidate list. The MV difference between the current MV and a selected MV candidate in the candidate list is coded.

Bi-Directional Optical Flow (BIO)

Bi-directional optical flow (BIO) is motion estimation/compensation technique disclosed in JCTVC-C204 (E. Alshina, et al., Bi-directional optical flow, Joint Collaborative Team on Video Coding (JCT-VC) of ITU-T SG 16 WP 3 and ISO/IEC JTC 1/SC 29/WG 11, 3rd Meeting: Guangzhou, CN, 7-15 Oct. 2010, Document: JCTVC-C204) and VCEG-AZ05 (E. Alshina, et al., Known tools performance investigation for next generation video coding, ITU-T SG 16 Question 6, Video Coding Experts Group (VCEG), 52^{nd} Meeting: 19-26 Jun. 2015, Warsaw, Poland, Document: VCEG-AZ05). BIO derived the sample-level motion refinement based on the assumptions of optical flow and steady motion as shown in FIG. 4, where a current pixel 422 in a B-slice (bi-prediction slice) 420 is predicted by one pixel in reference picture 0 and one pixel in reference picture 1. As shown in FIG. 4, the current pixel 422 is predicted by pixel B (412) in reference picture 1 (410) and pixel A (432) in reference picture 0 (430). In FIG. 4, vₓ and v_{y} are pixel displacement vector in the x-direction and y-direction, which are derived using a bi-direction optical flow (BIO) model. It is applied only for truly bi-directional predicted blocks, which is predicted from two reference frames corresponding to the previous frame and the latter frame. In VCEG-AZ05, BIO utilizes a 5×5 window to derive the motion refinement of each sample. Therefore, for an N×N block, the motion compensated results and corresponding gradient information of an (N+4)×(N+4) block are required to derive the sample-based motion refinement for the N×N block. According to VCEG-AZ05, a 6-Tap gradient filter and a 6-Tap interpolation filter are used to generate the gradient information for BIO. Therefore, the computation complexity of BIO is much higher than that of traditional bi-directional prediction. In order to further improve the performance of BIO, the following methods are proposed.

In VCEG-AZ05, the BIO is implemented on top of HEVC reference software and it is always applied for those blocks that are predicted in true bi-directions. In HEVC, one 8-tap interpolation filter for the luma component and one 4-tap interpolation filter for the chroma component are used to perform fractional motion compensation. Considering one 5×5 window for one to-be-processed pixel in one 8×8 CU in BIO, the required bandwidth in the worst case is increased from (8+7)×(8+7)×2/(8×8)=7.03 to (8+7+4)×(8+7+4)×2/(8×8)=11.28 reference pixels per current pixel.

Decoder-Side MV Refinement (DMVR)

In JVET-D0029 (Xu Chen, et al., “Decoder-Side Motion Vector Refinement Based on Bilateral Template Matching”, Joint Video Exploration Team (WET) of ITU-T SG 16 WP 3 and ISO/IEC JTC 1/SC 29/WG 11, 4th Meeting: Chengdu, CN, 15-21 Oct. 2016, Document: JVET-D0029), Decoder-Side Motion Vector Refinement (DMVR) based on bilateral template matching is disclosed. A template is generated by using the bi-prediction from the reference blocks (510 and 520) of MV0 and MV1, as shown in FIG. 5. Using the template as a new current block and perform the motion estimation to find a better matching block (610 and 620 respectively) in Ref. Picture 0 and Ref. Picture 1, respectively, as shown in FIG. 6. The refined MVs are the MV0′ and MV1′. Then the refined MVs (MV0′ and MV1′) are used to generate a final bi-predicted prediction block for the current block.

In DMVR, it uses two-stage search to refine the MVs of the current block. As shown in FIG. 7, for a current block, the cost of current MV candidate (at a current pixel location indicated by a square symbol 710) is first evaluated. In the first stage search, the integer-pixel search is performed around the current pixel location. Eight candidates (indicated by the eight large circles 720 in FIG. 7) are evaluated. The horizontal distance, vertical distance or both between two adjacent circles or between the square symbol and the adjacent circle is one pixel. The best candidate with the lowest cost is selected as the best MV candidate (e.g. candidate at location indicated by circle 730) in the first stage. In the second stage, a half-pixel square search is performed around the best MV candidate in the first stage, as shown as eight small circles in FIG. 7. The best MV candidate with the lowest cost is selected the final MV for the final motion compensation.

To compensate the fractional MV, the 8-tap interpolation filter is used in HEVC and JEM-4.0 (i.e., the reference software for JVET). In JEM-4.0, the MV precision is 1/16-pel. Sixteen 8-tap filters are used. The filter coefficients are as follow.

| | |
|---|---|
| 0/16-pixel: | { 0, 0, 0, 64, 0, 0, 0, 0 } |
| 1/16-pixel: | { 0, 1, −3, 63, 4, −2, 1, 0 } |
| 2/16-pixel: | { −1, 2, −5, 62, 8, −3, 1, 0 } |
| 3/16-pixel: | { −1, 3, −8, 60, 13, −4, 1, 0 } |
| 4/16-pixel: | { −1, 4, −10, 58, 17, −5, 1, 0 } |
| 5/16-pixel: | { −1, 4, −11, 52, 26, −8, 3, −1 } |
| 6/16-pixel: | { −1, 3, −9, 47, 31, −10, 4, −1 } |
| 7/16-pixel: | { −1, 4, −11, 45, 34, −10, 4, −1 } |
| 8/16-pixel: | { −1, 4, −11, 40, 40, −11, 4, −1 } |
| 9/16-pixel: | { −1, 4, −10, 34, 45, −11, 4, −1 } |
| 10/16-pixel: | { −1, 4, −10, 31, 47, −9, 3, −1 } |
| 11/16-pixel: | { −1, 3, −8, 26, 52, −11, 4, −1 } |
| 12/16-pixel: | { 0, 1, −5, 17, 58, −10, 4, −1 } |
| 13/16-pixel: | { 0, 1, −4, 13, 60, −8, 3, −1 } |
| 14/16-pixel: | { 0, 1, −3, 8, 62, −5, 2, −1 } |
| 15/16-pixel: | { 0, 1, −2, 4, 63, −3, 1, 0 } |

It is desirable to reduce the bandwidth requirement for the system utilizing PMVD BIO, DMVR or other motion refinement processes.

### BRIEF SUMMARY OF THE INVENTION

Method and apparatus of using predictor refinement process, such as Pattern-based MV derivation (PMVD), Bi-directional optical flow (BIO) or Decoder-side MV refinement (DMVR), to refine motion are disclosed. According to one method of the present invention, a target motion-compensated reference block associated with the current block in a target reference picture from a reference picture list is determined, where the target motion-compensated reference block includes additional surrounding pixels around a corresponding block of the current block in the target reference picture for performing interpolation filter required for any fractional motion vector of the current block. A valid reference block related to the target motion-compensated reference block is designated. The PMVD process, BIO process or DMVR process is applied to generate motion refinement for the current block by searching among multiple motion vector candidates using reference data comprising the target motion-compensated reference block, where if a target motion vector candidate requires target reference data from the target motion-compensated reference block being outside the valid reference block, the target motion vector candidate is excluded from said searching the multiple motion vector candidates or a replacement motion vector candidate closer to a center of the corresponding block of the current block is used as a replacement for the target motion vector candidate. The current block is encoded or decoded based on motion-compensated prediction according to the motion refinement.

In one embodiment, the DMVR process is used to generate the motion refinement and the valid reference block is equal to the target motion-compensated reference block. In another embodiment, the DMVR process is used to generate the motion refinement, the valid reference block corresponds to the target motion-compensated reference block plus a pixel ring around the target motion-compensated reference block. A table is used to specify the valid reference block in terms of a number of surrounding pixels around each side of the corresponding block of the current block associated with the interpolation filter for each fractional-pixel location.

In one embodiment, two different valid reference blocks are used for two different motion refinement processes, wherein the two different motion refinement processes are selected from a group comprising the PMVD process, BIO process or DMVR process. The process associated with said excluding the target motion vector candidate from said searching the multiple motion vector candidates or using the replacement motion vector candidate closer to a center of the corresponding block of the current block as a replacement for the target motion vector candidate in a case that the target motion vector candidate requires target reference data from the target motion-compensated reference block being outside the valid reference block is applied only applied to the current block larger than a threshold or the current block coded in bi-prediction.

In one embodiment, when a two-stage motion refinement process is used, second-stage motion vector candidates to be searched during a second-stage motion refinement process correspond to adding offsets to a corresponding non-replacement motion vector candidate derived in a first-stage motion refinement process. In another embodiment, when a two-stage motion refinement process is used, second-stage motion vector candidates to be searched during a second-stage motion refinement process correspond to adding offsets to the replacement motion vector candidate derived in a first-stage motion refinement process.

According to another method of the present invention, a target motion-compensated reference block associated with the current block in a target reference picture from a reference picture list is determined, where the target motion-compensated reference block includes additional surrounding pixels around a corresponding block of the current block in the target reference picture for performing interpolation filter required for any fractional motion vector of the current block. One or more target fractional-pixel locations are selected. The PMVD process, BIO process or DMVR process is applied to generate motion refinement for the current block by searching among multiple motion vector candidates using reference data comprising the target motion-compensated reference block, where if a target motion vector candidate belongs to said one or more target fractional-pixel locations, a reduced tap-length interpolation filter is applied to the target motion vector candidate. Said one or more target fractional-pixel locations correspond to pixel locations from (1/filter_precision) to ((filter_precision/2)/filter_precision) and from ((filter_precision/2+1)/filter_precision) to ((filter_precision−1)/filter_precision), and where filter_precision corresponds to motion vector precision.

According to yet another method of the present invention, for a selected motion estimation/compensation process involving sub-block based motion estimation/compensation, the current block is divided into current sub-blocks depending on whether prediction direction associated with the current block is bi-prediction or uni-prediction. Motion information associated with the sub-blocks is determined. The sub-blocks are encoded and decoded using motion-compensated prediction according to the motion information associated with the sub-blocks. A minimum block size of the current sub-blocks for the bi-prediction is larger than the minimum block size of the current sub-blocks for the uni-prediction.

### BRIEF DESCRIPTION OF THE DRAWINGS

FIG. 1 illustrates an example of motion compensation using the bilateral matching technique, where a current block is predicted by two reference blocks along the motion trajectory.

FIG. 2 illustrates an example of motion compensation using the template matching technique, where the template of the current block is matched with the reference template in a reference picture.

FIG. 3A illustrates an example of temporal motion vector prediction (MVP) derivation process for LIST_0 reference pictures.

FIG. 3B illustrates an example of temporal motion vector prediction (MVP) derivation process for LIST_1 reference pictures.

FIG. 4 illustrates an example of Bi-directional Optical Flow (BIO) to derive offset motion vector for motion refinement.

FIG. 5 illustrates an example of Decoder-Side Motion Vector Refinement (DMVR), where a template is generated first by using the bi-prediction from the reference blocks of MV0 and MV1.

FIG. 6 illustrates an example of Decoder-Side Motion Vector Refinement (DMVR) by using the template generated in FIG. 5 as a new current block and performing the motion estimation to find a better matching block in Ref. Picture 0 and Ref. Picture 1 respectively.

FIG. 7 illustrates an example of two-stage search to refine the MVs of the current block for Decoder-Side Motion Vector Refinement (DMVR).

FIG. 8 illustrates an example required reference data by Decoder-Side Motion Vector Refinement (DMVR) for an M×N block with fractional MVs, where a (M+L−1)*(N+L−1) reference block is required for motion compensation.

FIG. 9 illustrates an exemplary flowchart of a video coding system using predictor refinement process, such as Pattern-based MV derivation (PMVD), Bi-directional optical flow (BIO) or Decoder-side MV refinement (DMVR), to refine motion with reduced system bandwidth according to an embodiment of the present invention.

FIG. 10 illustrates an exemplary flowchart of a video coding system using predictor refinement process, such as Pattern-based MV derivation (PMVD), Bi-directional optical flow (BIO) or Decoder-side MV refinement (DMVR), to refine motion with reduced system bandwidth according to an embodiment of the present invention, where a reduced tap-length interpolation filter is applied to the target motion vector candidate if the target motion vector candidate belongs to one or more designated target fractional-pixel locations.

FIG. 11 illustrates an exemplary flowchart of a video coding system using a selected motion estimation/compensation process involving sub-block based motion estimation/compensation with reduced system bandwidth to refine motion according to an embodiment of the present invention, where the current block is divided into sub-blocks depending on whether prediction direction associated with the current block is bi-prediction or uni-prediction.

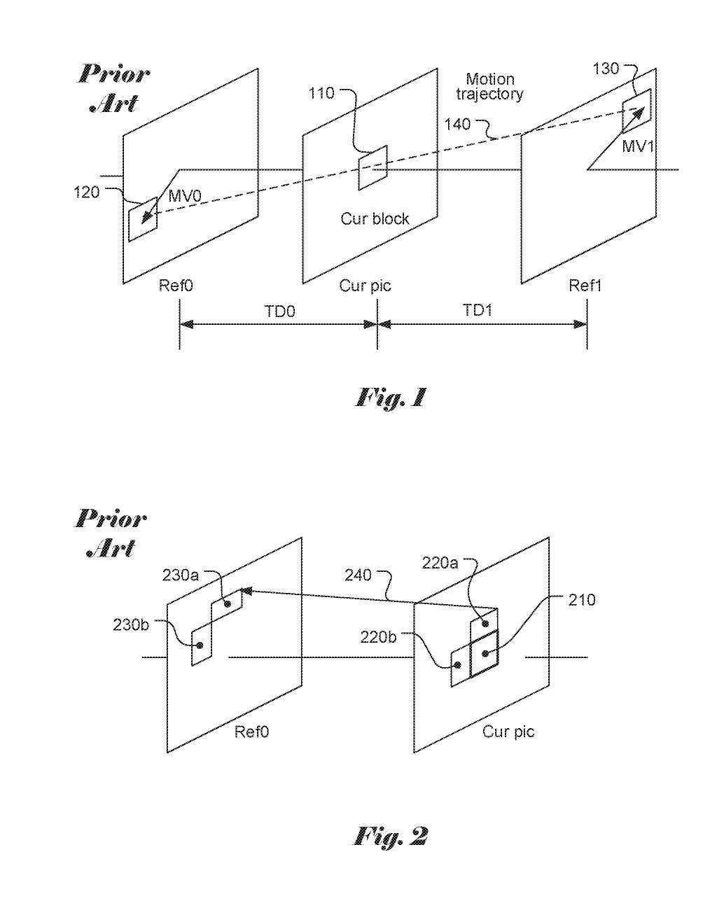

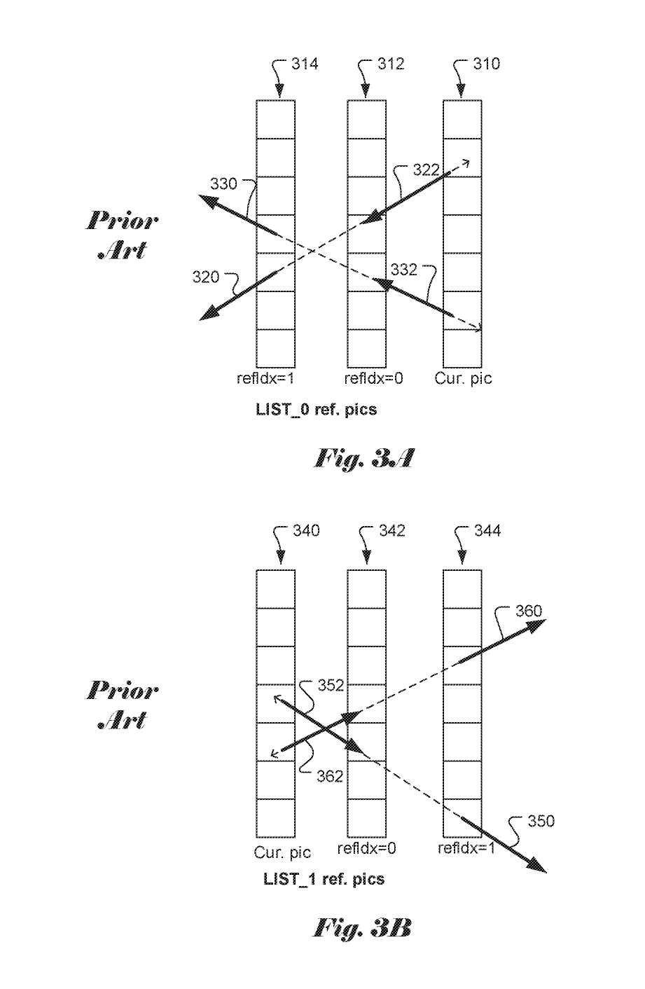

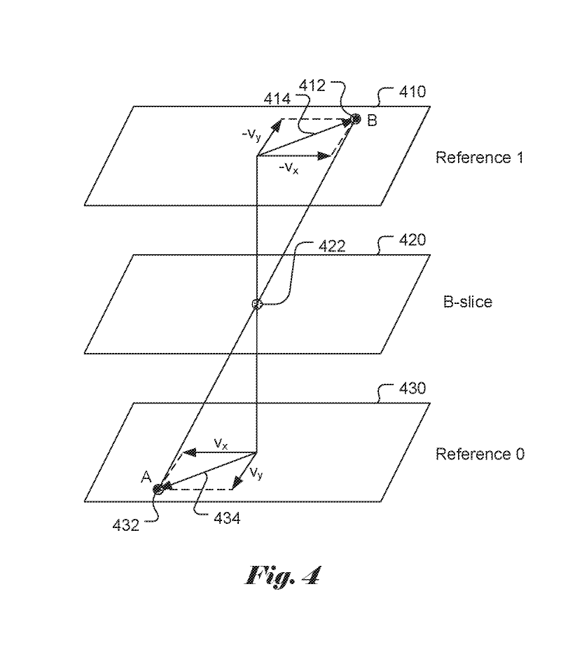

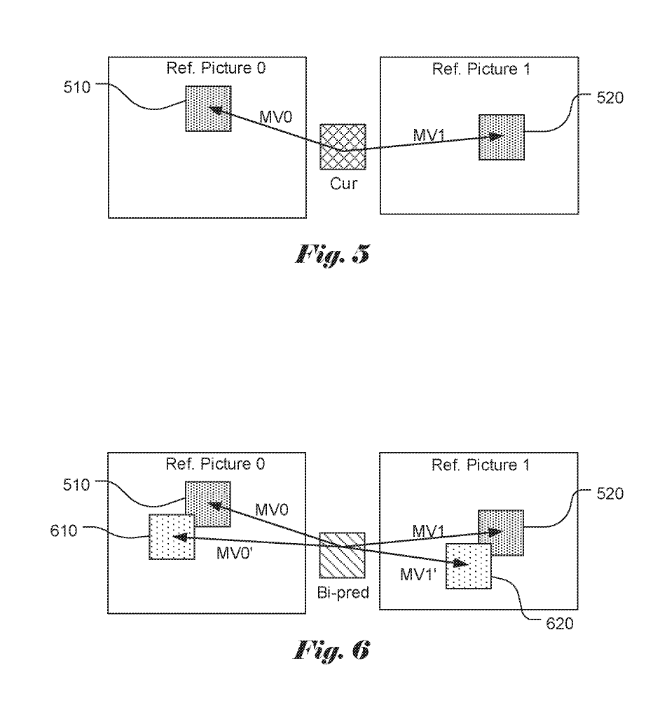

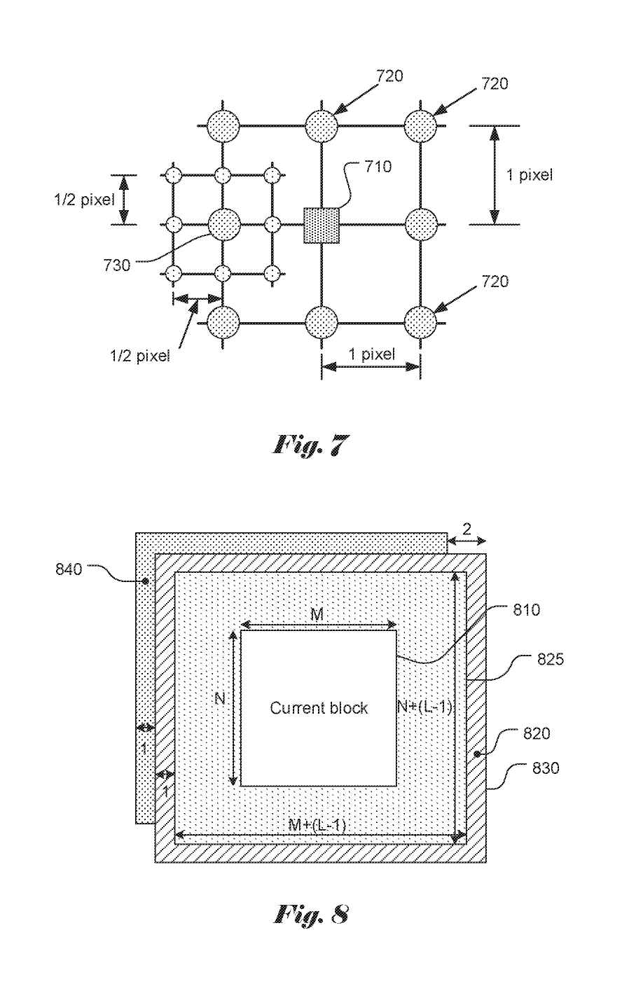

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned previously, various predictor refinement techniques such as Pattern-based MV derivation (PMVD), Bi-directional Optical Flow (BIO) or Decoder-Side Motion Vector Refinement (DMVR) require accessing additional reference data, which causes increased system bandwidth. For example, for an M×N block 810 with fractional MVs, an (M+L−1)*(N+L−1) reference block 825 is required for motion compensation as shown in FIG. 8, where the L is the interpolation filter tap length. In HEVC, L is equal to 8. For DMVR search, ring area 820 with one-pixel width outside the reference block 825 is required for the first stage search within the (M+L−1)*(N+L−1) reference block 825 plus the ring area 820. The area corresponding to reference block 825 plus the ring area 820 is referred as reference pixel area 830. If the best candidate is located at upper left side instead of the center candidate, additional data outside the ring area 820 may be needed. For example, an additional L shape area 840 (i.e. an additional one (M+L−1) pixel row and (N+L−1) pixel column) are required. The additional reference pixels required for supporting the predictor refinement tools implies additional bandwidth. In the present invention, techniques to reduce the system bandwidth associated with PMVD, BIO and DMVR are disclosed.

In JEM-4.0, while the 8-tap filter is used, not every filter has eight coefficients. For example, the filter only has 7 coefficients in 3/16-pixel filter and it only has 6 coefficients in 1/16-pixel filter. Therefore, for some MV candidates, the actually required reference pixels are smaller than what it mentioned in FIG. 8. For example, if the center MV candidate is located at (11/16, 11/16), it requires a (M+7)*(N+7) pixels block. For the first stage search, the eight MV candidates are located at (11/16±1, 11/16±1)(i.e., (11/16, 11/16+1), (11/16, 11/16−1), (11/16+1, 11/16+1), (11/16+1, 11/16), (11/16+1, 11/16−1), (11/16−1, 11/16+1), (11/16−1, 11/16), (11/16−1, 11/16−1)), and it requires a (M+7+1+1)*(N+7+1+1) pixels block (i.e., reference area 830 in FIG. 8). If the best candidate is (11/16+1, 11/16), the eight candidates for second-stage search are (11/16+1±8/16, 11/16±8/16)(i.e., (11/16+1, 11/16), (11/16+1, 11/16−8/16), (11/16+1+8/16, 11/16+8/16), (11/16+1+8/16, 11/16), (11/16+1+8/16, 11/16−8/16), (11/16+1−8/16, 11/16+8/16), (11/16+1−8/16, 11/16), (11/16+1−8/16, 11/16−8/16)). For the (11/16+1+8/16, 11/16) candidate, the 3/16-pixel filter is used. The 3/16-pixel filter only has 7 coefficients with only 3 coefficients on the right hand side of the current pixel, which means that there is no additional reference pixel is required for the MC of the (11/16+1+8/16, 11/16) candidate. Therefore, the fractional MV position and the filter coefficients will affect how many pixels are required for the refinement. In order to reduce the bandwidth, three methods are disclosed as follows.

Method-1: Candidate Skipping

To reduce the bandwidth requirement, it is proposed to skip searching the candidates that require additional memory access. A table is created to list how many pixels in the right-hand side and left-hand side are used for the filters. For example, Table 1 shows the required pixels on the left side and the right side of the current pixel. For the predictor refinement tools (e.g. PMVD, DMVR, and BIO), a valid reference block is first defined. For example, the valid reference block can be the (M+(L−1))*(N+(L−1)) block (i.e., reference area 825 in FIG. 8) or the (M+L+1)*(N+L+1) block (i.e., reference area 830 in FIG. 8) for the DMVR case. In the refinement processing, if the candidate requires the reference pixels outside of the valid block, the candidate is skipped. In the case of DMVR, the skipped decision can be made based on the fractional MV position and the pixel requirement of filter as listed in Table 1. For example, if a one-dimensional interpolation is used and the (M+(L−1)+1+1)*(N+(L−1)+1+1) pixels block is defined as the valid block, it means the valid block includes (L/2)+1 pixels on the left side to (L/2)+1 pixels on the right side of the current pixel. In JEM-4.0, the L is 8, which means there are 5 pixels to left of the current pixel and 5 pixels to the right of the current pixel. For the required pixels of the left-hand side and the right-hand side, we can use the following equation.

### Left:

integer_part_of(refine_offset+fractional_part_of_org_MV)+Filter_required_pixel_left[(fractional_part_of(refine_offset+fractional_part_of_org_MV)% filter_precision] (1)

### Right:

integer_part_of(refine_offset+fractional_part_of_org_MV)+Filter_required_pixel_right[(fractional_part_of(refine_offset+fractional_part_of_org_MV)% filter_precision] (2)

TABLE 1
Pixels requirement of JEM-4.0 luma interpolation filter

| | Left | Right |
|---|---|---|
| | Filter_required_pixel_left | Filter_required_pixel_right |
| 0/16-pixel: | 1 | 0 |
| 1/16-pixel: | 3 | 3 |
| 2/16-pixel: | 4 | 3 |
| 3/16-pixel: | 4 | 3 |
| 4/16-pixel: | 4 | 3 |
| 5/16-pixel: | 4 | 4 |
| 6/16-pixel: | 4 | 4 |
| 7/16-pixel: | 4 | 4 |
| 8/16-pixel: | 4 | 4 |
| 9/16-pixel: | 4 | 4 |
| 10/16-pixel: | 4 | 4 |
| 11/16-pixel: | 4 | 4 |
| 12/16-pixel: | 3 | 4 |
| 13/16-pixel: | 3 | 4 |
| 14/16-pixel: | 3 | 4 |
| 15/16-pixel: | 3 | 3 |

For example, if the center MV_x candidate is 3/16, from Table 1, it requires 4 pixels in the left hand side and 3 pixels in the right hand side. For the first stage search, the MV_x corresponding to the (3/16+1) and (3/16−1) candidates are required to be searched. For MV_x corresponding to the (3/16−1) candidate, it requires one more pixel for the left hand side pixels, which are 5 pixels. For MV_x of (3/16+1) candidate, it requires one more pixel for the right hand side pixels, which are 4 pixels. Therefore, both the (3/16+1) and (3/16−1) candidates are available for searching. If the best MV_x candidate is (3/16−1), the candidates at half-pixel distance from the best MV_x candidate (i.e., (3/16−1+8/16) and (3/16−1−8/16) candidates) are required to be searched. For MV_x corresponding to the (3/16−1−8/16) candidate, the MV_x is equivalent to (−2+11/16). The integer_part_of (refine_offset+fractional_part_of_org_MV) is 2, and the (fractional_part_of (refine_offset+fractional_part_of_org_MV) % filter_precision is 11 according to equations (1) and (2), where the filter_precision is 16. It requires 2+4 pixels for the left-hand side, where 2 is from the “−2” and 4 is from the “11/16-pixel filter”. Therefore the MV_x corresponding to the (3/16−1−8/16) candidate requires more reference pixels than the valid block and the MV_x corresponding to the (3/16−1−8/16) candidate should be skipped.

Method-2: Candidate Replacement

Similar to method-1, the valid block is first defined and the required pixels are calculated according to equations (1) and (2). However, if the candidate is not valid, instead of skipping the candidate, it is proposed to move the candidate closer to the center (initial) MV. For example, if the MV_x of a candidate is (X−1) is not valid where X is the initial MV and “− 1” is the refinement offset, the candidate location is shift to (X−8/16) or (X−12/16) or anyone candidate between X to (X−1) (e.g. the valid candidate closest to (X−1)). In this way, a similar number of candidates can be examined while no additional bandwidth is required. In one embodiment, for the second stage searching, if its first stage candidate is a replacement candidate, the reference first stage offset should use the non-replaced offset. For example, if the original candidate of the first stage search is (X−1) and is not a valid candidate, it is replaced by (X−12/16). For the second stage candidate, it still can use (X−1±8/16) for second-stage search. In another embodiment, for the second-stage search, if the first stage candidate is a replacement candidate, the reference first stage offset should use the replaced offset. For example, if the original candidate of the first stage search is (X−1) and is not a valid candidate, it is replaced to be (X−12/16). For the second-stage candidate, it can use (X−12/16±8/16) for second-stage search. In another embodiment, if the first stage candidate is a replacement candidate, the offset of second-stage search can be reduced.

In method-1 and metho-2, different coding tool can have different valid reference block setting. For example, for DMVR, the valid block can be the (M+L−1)*(N+L−1) block. For PMVD, the valid block can be the (M+L−1+0)*(N+L−1+P) block, where the 0 and P can be 4.

In PMVD, the two-stage search is performed. The first stage is the PU-level search. The second stage is the sub-PU-level search. In the proposed method, the valid reference block constraint is applied for both the first stage search and the second stage search. The valid reference block of these two stages can be the same.

The proposed method-1 and metho-2 can be limited to be applied for the certain CUs or PUs. For example, the proposed method can be applied for the CU with the CU area larger than 64 or 256, or applied for the bi-prediction blocks.

Method-3: Shorter Filter Tap Design

In method-3, it is proposed to reduce the required pixels for filter locations from (1/filter_precision) to ((filter_precision/2−1)/filter_precision), and filter locations from ((filter_precision/2+1)/filter_precision) to ((filter_precision−1)/filter_precision) filter. For example, in JEM-4.0, it is proposed to reduce the required pixels for filters corresponding to 1/16-pixel to 7/16-pixel, and for filters corresponding to 9/16-pixel to 15/16-pixel. If a 6-tap filter is used for filters corresponding to 1/16-pixel to 7/16-pixel and for filters corresponding to 9/16-pixel to 15/16-pixel, there is no additional bandwidth is required for second stage search of DMVR.

Prediction Direction Dependent PU Splitting

In some coding tools, the current PU will be split into multiple sub-PUs if certain constraints are satisfied. For example, in JEM-4.0, ATMVP (advance TMVP), PMVD, BIO, and affine prediction/compensation will split the current PU into sub-PUs. To reduce the worst case bandwidth, it is proposed to split the current PU into different sizes according to the prediction directions. For example, the minimum size/area/width/height is M for bi-prediction block and the minimum size/area/width/height is N for uni-prediction block. For example, the minimum area for bi-prediction can be 64 and the minimum area for uni-prediction can be 16. In another example, the minimum width/height for bi-prediction can be 8 and the minimum width/height for uni-prediction can be 4.

In another example, for ATMVP merge mode, if the MV candidate is bi-prediction, the minimum sub-PU area is 64. If the MV candidate is uni-prediction, the minimum sub-PU area can be 16.

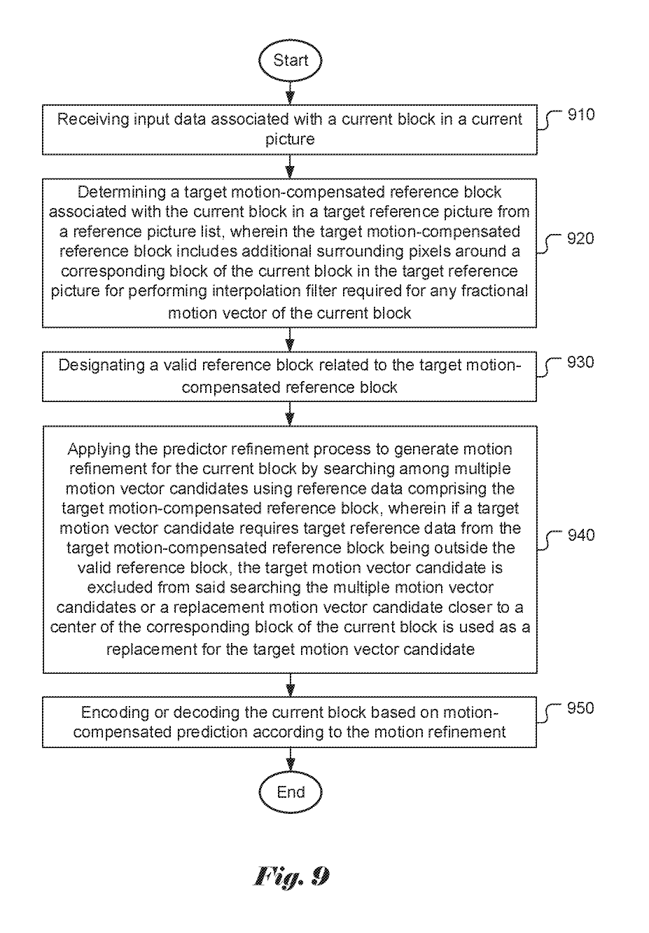

FIG. 9 illustrates an exemplary flowchart of a video coding system using decoder-side predictor refinement process, such as Pattern-based MV derivation (PMVD), Bi-directional optical flow (BIO) or Decoder-side MV refinement (DMVR), to refine motion/predictor with reduced system bandwidth according to an embodiment of the present invention. The steps shown in the flowchart, as well as other flowcharts in this disclosure, may be implemented as program codes executable on one or more processors (e.g., one or more CPUs) at the encoder side and/or the decoder side. The steps shown in the flowchart may also be implemented based on hardware such as one or more electronic devices or processors arranged to perform the steps in the flowchart. According to this method, input data associated with a current block in a current picture is received in step 910. A target motion-compensated reference block associated with the current block in a target reference picture from a reference picture list is determined in step 920, where the target motion-compensated reference block includes additional surrounding pixels around a corresponding block of the current block in the target reference picture for performing interpolation filter required for any fractional motion vector of the current block. A valid reference block related to the target motion-compensated reference block is designated in step 930. The predictor refinement process, such as PMVD process, BIO process or DMVR process, is applied to generate motion refinement for the current block by searching among multiple motion vector candidates using reference data comprising the target motion-compensated reference block in step 940, where if a target motion vector candidate requires target reference data from the target motion-compensated reference block being outside the valid reference block, the target motion vector candidate is excluded from said searching the multiple motion vector candidates or a replacement motion vector candidate closer to a center of the corresponding block of the current block is used as a replacement for the target motion vector candidate. The current block is encoded or decoded based on motion-compensated prediction according to the motion refinement in step 950.

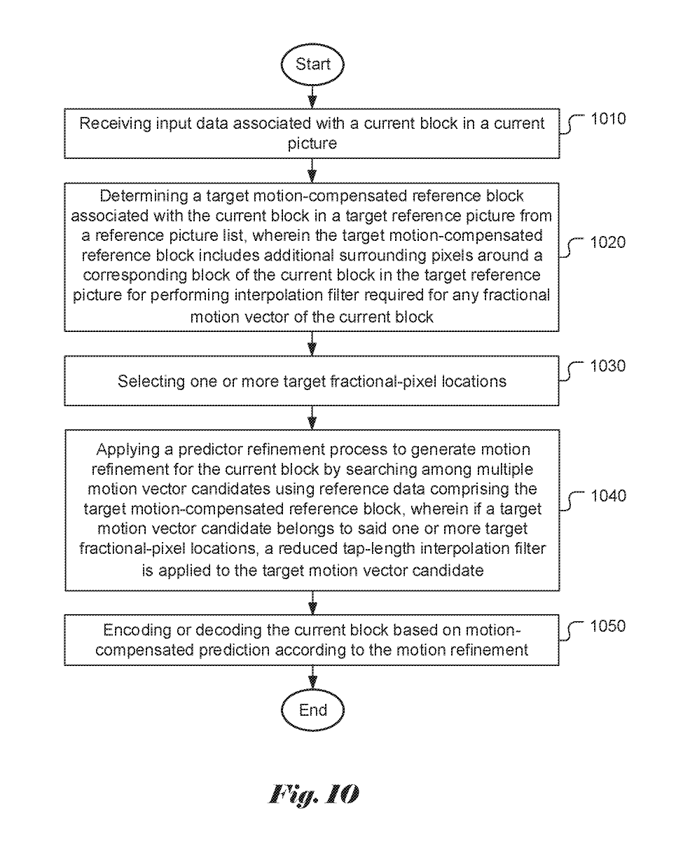

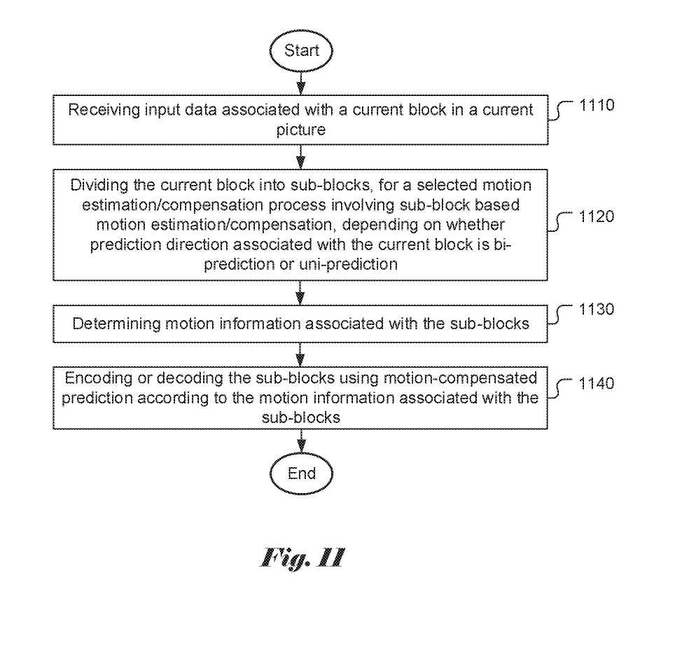

FIG. 10 illustrates an exemplary flowchart of a video coding system using predictor refinement process, such as Pattern-based MV derivation (PMVD), Bi-directional optical flow (BIO) or Decoder-side MV refinement (DMVR), to refine motion with reduced system bandwidth according to an embodiment of the present invention, where a reduced tap-length interpolation filter is applied to the target motion vector candidate if the target motion vector candidate belongs to one or more designated target fractional-pixel locations. According to this method, input data associated with a current block in a current picture is received in step 1010. A target motion-compensated reference block associated with the current block in a target reference picture from a reference picture list is determined in step 1020, where the target motion-compensated reference block includes additional surrounding pixels around a corresponding block of the current block in the target reference picture for performing interpolation filter required for any fractional motion vector of the current block. One or more target fractional-pixel locations are selected in step 1030. The predictor refinement process, such as PMVD process, BIO process or DMVR process, is applied to generate motion refinement for the current block by searching among multiple motion vector candidates using reference data comprising the target motion-compensated reference block in step 1040, where if a target motion vector candidate belongs to said one or more target fractional-pixel locations, a reduced tap-length interpolation filter is applied to the target motion vector candidate. The current block is encoded or decoded based on motion-compensated prediction according to the motion refinement in step 1050.

FIG. 11 illustrates an exemplary flowchart of a video coding system using a selected motion estimation/compensation process involving sub-block based motion estimation/compensation, such as Advance Temporal Motion Vector Prediction (ATMVP), Pattern-based MV derivation (PMVD), Bi-directional optical flow (BIO) or affine prediction/compensation, with reduced system bandwidth to refine motion according to an embodiment of the present invention, where the current block is divided into sub-blocks depending on whether prediction direction associated with the current block is bi-prediction or uni-prediction. According to this method, input data associated with a current block in a current picture is received in step 1110. For a selected motion estimation/compensation process involving sub-block based motion estimation/compensation, the current block is divided into current sub-blocks in step 1120 depending on whether prediction direction associated with the current block is bi-prediction or uni-prediction. Motion information associated with the sub-blocks is determined in step 1130. The sub-blocks are encoded or decoded using motion-compensated prediction according to the motion information associated with the sub-blocks in step 1140.

The flowcharts shown above are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding using a predictor refinement process to refine motion for a block, the method comprising:
receiving input data associated with a current block in a current picture;
determining a target motion-compensated reference block associated with the current block in a target reference picture from a reference picture list, wherein the target motion-compensated reference block includes additional surrounding pixels around a corresponding block of the current block in the target reference picture for performing interpolation filter required for any fractional motion vector of the current block;
designating a valid reference block related to the target motion-compensated reference block;
applying the predictor refinement process to generate motion refinement for the current block by searching among multiple motion vector candidates using reference data comprising the target motion-compensated reference block, wherein if a target motion vector candidate requires target reference data from the target motion-compensated reference block being outside the valid reference block, the target motion vector candidate is excluded from said searching the multiple motion vector candidates or a replacement motion vector candidate closer to a center of the corresponding block of the current block is used as a replacement for the target motion vector candidate; and
encoding or decoding the current block based on motion-compensated prediction according to the motion refinement.

2. The method of claim 1, wherein the predictor refinement process corresponds to Pattern-based MV derivation (PMVD), Bi-directional optical flow (BIO) or Decoder-side MV refinement (DMVR).

3. The method of claim 2, wherein the DMVR is used to generate the motion refinement and the valid reference block is equal to the target motion-compensated reference block.

4. The method of claim 2, wherein the DMVR is used to generate the motion refinement, the valid reference block corresponds to the target motion-compensated reference block plus a pixel ring around the target motion-compensated reference block.

5. The method of claim 1, wherein a table is used to specify the valid reference block in terms of a number of surrounding pixels around each side of the corresponding block of the current block associated with the interpolation filter for each fractional-pixel location.

6. The method of claim 1, wherein two different valid reference blocks are used for two different motion refinement processes, wherein the two different motion refinement processes are selected from a group comprising Pattern-based MV derivation (PMVD), Bi-directional optical flow (BIO) or Decoder-side MV refinement (DMVR).

7. The method of claim 1, wherein a process associated with excluding the target motion vector candidate from said searching the multiple motion vector candidates or using the replacement motion vector candidate closer to a center of the corresponding block of the current block as a replacement for the target motion vector candidate in a case that the target motion vector candidate requires target reference data from the target motion-compensated reference block being outside the valid reference block is only applied to the current block larger than a threshold or the current block coded in bi-prediction.

8. The method of claim 1, wherein when a two-stage motion refinement process is used, second-stage motion vector candidates to be searched during a second-stage motion refinement process correspond to adding offsets to a corresponding non-replacement motion vector candidate derived in a first-stage motion refinement process.

9. The method of claim 1, wherein when a two-stage motion refinement process is used, second-stage motion vector candidates to be searched during a second-stage motion refinement process correspond to adding offsets to the replacement motion vector candidate derived in a first-stage motion refinement process.

10. An apparatus for video coding using a predictor refinement process to refine motion for a block, the apparatus of video coding comprising one or more electronic circuits or processors arranged to:
receive input data associated with a current block in a current picture;
determine a target motion-compensated reference block associated with the current block in a target reference picture from a reference picture list, wherein the target motion-compensated reference block includes additional surrounding pixels around a corresponding block of the current block in the target reference picture for performing interpolation filter required for any fractional motion vector of the current block;
designate a valid reference block related to the target motion-compensated reference block;
apply the predictor refinement process to generate motion refinement for the current block by searching among multiple motion vector candidates using reference data comprising the target motion-compensated reference block, wherein if a target motion vector candidate requires target reference data from the target motion-compensated reference block being outside the valid reference block, the target motion vector candidate is excluded from said searching the multiple motion vector candidates or a replacement motion vector candidate closer to a center of the corresponding block of the current block is used as a replacement for the target motion vector candidate; and
encode or decode the current block based on motion-compensated prediction according to the motion refinement.

11. The apparatus of claim 10, wherein the predictor refinement process corresponds to Pattern-based MV derivation (PMVD), Bi-directional optical flow (BIO) or Decoder-side MV refinement (DMVR).

12. A non-transitory computer readable medium storing program instructions causing a processing circuit of an apparatus to perform a video coding method, and the method comprising:
receiving input data associated with a current block in a current picture;
determining a target motion-compensated reference block associated with the current block in a target reference picture from a reference picture list, wherein the target motion-compensated reference block includes additional surrounding pixels around a corresponding block of the current block in the target reference picture for performing interpolation filter required for any fractional motion vector of the current block;
designating a valid reference block related to the target motion-compensated reference block;
applying the a predictor refinement process to generate motion refinement for the current block by searching among multiple motion vector candidates using reference data comprising the target motion-compensated reference block, wherein if a target motion vector candidate requires target reference data from the target motion-compensated reference block being outside the valid reference block, the target motion vector candidate is excluded from said searching the multiple motion vector candidates or a replacement motion vector candidate closer to a center of the corresponding block of the current block is used as a replacement for the target motion vector candidate; and
encoding or decoding the current block based on motion-compensated prediction according to the motion refinement.

13. The method of claim 12, wherein the decoder-side predictor refinement process technique corresponds to Pattern-based MV derivation (PMVD), Bi-directional optical flow (BIO) or Decoder-side MV refinement (DMVR).

14. A method of video coding using a predictor refinement process to refine motion for a block, the method comprising:
receiving input data associated with a current block in a current picture;
determining a target motion-compensated reference block associated with the current block in a target reference picture from a reference picture list, wherein the target motion-compensated reference block includes additional surrounding pixels around a corresponding block of the current block in the target reference picture for performing interpolation filter required for any fractional motion vector of the current block;
selecting one or more target fractional-pixel locations;
applying the predictor refinement process to generate motion refinement for the current block by searching among multiple motion vector candidates using reference data comprising the target motion-compensated reference block, wherein if a target motion vector candidate belongs to said one or more target fractional-pixel locations, a reduced tap-length interpolation filter is applied to the target motion vector candidate; and
encoding or decoding the current block based on motion-compensated prediction according to the motion refinement.

15. The method of claim 14, wherein the predictor refinement process corresponds to Pattern-based MV derivation (PMVD), Bi-directional optical flow (BIO) or Decoder-side MV refinement (DMVR).

16. The method of claim 14, wherein said one or more target fractional-pixel locations correspond to pixel locations from (1/filter_precision) to ((filter_precision/2)/filter_precision) and from ((filter_precision/2+1)/filter_precision) to ((filter_precision−1)/filter_precision), and wherein filter_precision corresponds to motion vector precision.

17. An apparatus for video coding using a predictor refinement process to refine motion for a block, the apparatus of video coding comprising one or more electronic circuits or processors arranged to:
receive input data associated with a current block in a current picture;
determine a target motion-compensated reference block associated with the current block in a target reference picture from a reference picture list, wherein the target motion-compensated reference block includes additional surrounding pixels around a corresponding block of the current block in the target reference picture for performing interpolation filter required for any fractional motion vector of the current block;
select one or more target fractional-pixel locations;
apply the predictor refinement process to generate motion refinement for the current block by searching among multiple motion vector candidates using reference data comprising the target motion-compensated reference block, wherein if a target motion vector candidate belongs to said one or more target fractional-pixel locations, a reduced tap-length interpolation filter is applied to the target motion vector candidate; and
encode or decode the current block based on motion-compensated prediction according to the motion refinement.

18. The apparatus of claim 17, wherein the predictor refinement process corresponds to Pattern-based MV derivation (PMVD), Bi-directional optical flow (BIO) or Decoder-side MV refinement (DMVR).

19. A non-transitory computer readable medium storing program instructions causing a processing circuit of an apparatus to perform a video coding method, and the method comprising:
receiving input data associated with a current block in a current picture;
determining a target motion-compensated reference block associated with the current block in a target reference picture from a reference picture list, wherein the target motion-compensated reference block includes additional surrounding pixels around a corresponding block of the current block in the target reference picture for performing interpolation filter required for any fractional motion vector of the current block;
selecting one or more target fractional-pixel locations;
applying a decoder-side predictor refinement process to generate motion refinement for the current block by searching among multiple motion vector candidates using reference data comprising the target motion-compensated reference block, wherein if a target motion vector candidate belongs to said one or more target fractional-pixel locations, a reduced tap-length interpolation filter is applied to the target motion vector candidate; and
encoding or decoding the current block based on motion-compensated prediction according to the motion refinement.

20. The method of claim 19, wherein the decoder-side predictor refinement process corresponds to is Pattern-based MV derivation (PMVD), Bi-directional optical flow (BIO) or Decoder-side MV refinement (DMVR).

21. A method of video coding using sub-block partition to refine a predictor for a current block, the method comprising:
receiving input data associated with a current block in a current picture;
dividing the current block into sub-blocks, for a selected motion estimation/compensation process involving sub-block based motion estimation/compensation, depending on whether prediction direction associated with the current block is bi-prediction or uni-prediction;
determining motion information associated with the sub-blocks; and
encoding or decoding the sub-blocks using motion-compensated prediction according to the motion information associated with the sub-blocks.

22. The method of claim 21, wherein a minimum block size of the sub-blocks for the bi-prediction is larger than the minimum block size of the sub-blocks for the uni-prediction.

23. The method of claim 21, the selected motion estimation/compensation process belongs to a group comprising of Advance Temporal Motion Vector Prediction (ATMVP), Pattern-based MV derivation (PMVD), Bi-directional optical flow (BIO) or affine prediction/compensation.

24. An apparatus for video coding using a sub-block partition technology to refine motion for a current block, the apparatus of video coding comprising one or more electronic circuits or processors arranged to:
receive input data associated with a current block in a current picture;
dividing the current block into sub-blocks, for a selected motion estimation/compensation process involving sub-block based motion estimation/compensation, depending on whether prediction direction associated with the current block is bi-prediction or uni-prediction;
determining motion information associated with the sub-blocks; and
encoding or decoding the sub-blocks using motion-compensated prediction according to the motion information associated with the sub-blocks.

25. A non-transitory computer readable medium storing program instructions causing a processing circuit of an apparatus to perform a video coding method, and the method comprising:
receiving input data associated with a current block in a current picture;
dividing the current block into current sub-blocks, for a selected motion estimation/compensation process involving sub-block based motion estimation/compensation, depending on whether prediction direction associated with the current block is bi-prediction or uni-prediction;
determining motion information associated with the sub-blocks; and
encoding or decoding the current sub-blocks using motion-compensated prediction according to the motion information associated with the of current sub-blocks.
